(19) United States
(12) Patent Application Publication
(10) Pub. No.: US 2019/0287189 A1
(43) Pub. Date: Sep. 19, 2019

(54) PART SUPPLY AMOUNT ESTIMATING DEVICE AND MACHINE LEARNING DEVICE

(71) Applicant: FANUC Corporation, Yamanashi (JP)

(72) Inventors: Yuuki OONISHI, Yamanashi (JP); Masataka KOIKE, Yamanashi (JP)

(21) Appl. No.: 16/296,576

(22) Filed: Mar. 8, 2019

(30) Foreign Application Priority Data
Mar. 16, 2018 (JP) 2018-049551

(51) Int. Cl. G06Q 50/04; G06N 20/00; G06N 5/04; G06Q 10/06

(52) U.S. Cl. CPC G06Q 50/04; G06N 20/00; G06N 3/04; G06Q 10/06315; G06N 5/048

(57) ABSTRACT

A machine learning device included in a part supply amount estimating device which can estimate an appropriate number of parts necessary to manufacture a manufacturing product includes: a state observing unit that observes manufacturing product data and manufacturing environment data as a state variable, the manufacturing product data indicating information related to the manufacturing product, the manufacturing environment data indicating information related to machining environment for manufacturing the manufacturing product, and the state variable indicating a current state of environment; a label data obtaining unit that obtains the part margin necessary to manufacture the manufacturing product as label data; and a learning unit that associates and learns the information related to the manufacturing product and the information related to the machining environment for manufacturing the manufacturing product, and the part margin necessary to manufacture the manufacturing product by using the state variable and the label data.

### RELATED APPLICATIONS

The present application claims priority to Japanese Application Number 2018-049551 filed Mar. 16, 2018, the disclosure of which is hereby incorporated by reference herein in its entirety.

### BACKGROUND OF THE INVENTION

### 1. Field of the Invention

The present invention relates to a part supply amount estimating device and a machine learning device.

### 2. Description of the Related Art

In a factory, a manufacturing facility in which a plurality of manufacturing machines such as a machine tool and a robot is disposed manufactures manufacturing products. Parts used to manufacture manufacturing products by the manufacturing facility are managed per manufacturing facility. An operator supplies a number of parts necessary to manufacture only a target number of manufacturing products, and replenishes the parts to the manufacturing facility. As described in Japanese Patent Application Laid-Open No. 2005-251059, defective parts are mixed among the supplied parts, and manufactured manufacturing products include rejected parts. Therefore, an operator predicts a rate of defective parts and a rate of rejected parts to determine a larger number of parts to supply such that it is possible to finally manufacture only the target number of manufacturing products (accepted parts).

The above will be described with reference to FIGS. 6 and 7. When, for example, ten parts are necessary to manufacture one manufacturing product, and, in an ideal situation that, as illustrated in FIG. 6, defective parts are not mixed among ordered parts and manufactured manufacturing products do not include rejected parts, if 1000 parts are supplied, 100 manufacturing products can be manufactured. However, when 2% or less of defective parts are likely to be mixed among the ordered parts and 3% or less of rejected parts are likely to be manufactured during manufacturing as illustrated in FIG. 7, 1050 parts need to be supplied a little more by taking into account the numbers of defective parts and rejected parts in advance.

When manufacturing of manufacturing products is finished, and parts necessary to manufacture manufacturing products become a surplus, the parts become a surplus stock as long as manufacturing products which use the same parts are not manufactured. Hence, the operator needs to supply a sufficient number of parts for manufacturing a target number of manufacturing products while preventing a surplus stock as much as possible. However, a probability of defective parts and rejected parts depends on a manufacturing method and environment of manufacturing products. Therefore, a rule of thumb is necessary to determine a margin of the number of parts, and, until a margin of an appropriate number of parts is found out, labor for supply, management of information related to manufacturing, and management of a part stock is required and is a burden for the operator. Hence, there is a demand that even a less experienced operator is able to supply an appropriate number of parts from the beginning.

### SUMMARY OF THE INVENTION

It is therefore an object of the present invention to provide a part supply amount estimating device and a machine learning device which can estimate an appropriate number of parts which are necessary to manufacture manufacturing products.

The present invention can learn a defective part rate or a rejected part rate matching a manufacturing product type and machining environment by using a machine learning method, and precisely estimate a part margin necessary to manufacture manufacturing products, so and, consequently, can solve the above problem.

Furthermore, one aspect of the present invention is a part supply amount estimating device that estimates a part margin used to manufacture a manufacturing product, and includes a machine learning device that learns the part margin used to manufacture the manufacturing product, and the machine learning device includes: a state observing unit that observes manufacturing product data and manufacturing environment data as a state variable, the manufacturing product data indicating information related to the manufacturing product, the manufacturing environment data indicating information related to machining environment for manufacturing the manufacturing product, and the state variable indicating a current state of environment; a label data obtaining unit that obtains the part margin necessary to manufacture the manufacturing product as label data; and a learning unit that associates and learns the information related to the manufacturing product and the information related to the machining environment for manufacturing the manufacturing product, and the part margin necessary to manufacture the manufacturing product by using the state variable and the label data.

Another aspect of the present invention is a part supply amount estimating device that estimates a part margin used to manufacture a manufacturing product, and includes a machine learning device that learns the part margin used to manufacture the manufacturing product, and the machine learning device includes: a state observing unit that observes manufacturing product data and manufacturing environment data as a state variable, the manufacturing product data indicating information related to the manufacturing product, the manufacturing environment data indicating information related to machining environment for manufacturing the manufacturing product, and the state variable indicating a current state of environment; a learning unit that associates and learns the information related to the manufacturing product and the information related to the machining environment for manufacturing the manufacturing product, and the part margin necessary to manufacture the manufacturing product; and an estimation result output unit that outputs a result obtained by estimating the part margin necessary to manufacture the manufacturing product, based on the state variable observed by the state observing unit and a learning result of the learning unit.

Still another aspect of the present invention is a machine learning device that learns a part margin used to manufacture a manufacturing product, and includes: a state observing unit that observes manufacturing product data and manufacturing environment data as a state variable, the manufacturing product data indicating information related to the manufacturing product, the manufacturing environment data indicating information related to machining environment for manufacturing the manufacturing product, and the state variable indicating a current state of environment; a label data obtaining unit that obtains the part margin necessary to manufacture the manufacturing product as label data; and a learning unit that associates and learns the information related to the manufacturing product and the information related to the machining environment for manufacturing the manufacturing product, and the part margin necessary to manufacture the manufacturing product by using the state variable and the label data.

Yet still another aspect of the present invention is a machine learning device that learns a part margin used to manufacture a manufacturing product, and includes: a state observing unit that observes manufacturing product data and manufacturing environment data as a state variable, the manufacturing product data indicating information related to the manufacturing product, the manufacturing environment data indicating information related to machining environment for manufacturing the manufacturing product, and the state variable indicating a current state of environment; a learning unit that associates and learns the information related to the manufacturing product and the information related to the machining environment for manufacturing the manufacturing product, and the part margin necessary to manufacture the manufacturing product; and an estimation result output unit that outputs a result obtained by estimating the part margin necessary to manufacture the manufacturing product, based on the state variable observed by the state observing unit and a learning result of the learning unit.

According to the present invention, it is possible to precisely estimate an appropriate number of parts necessary to manufacture manufacturing products based on information related to the manufacturing products and information related to manufacturing environment.

### BRIEF DESCRIPTION OF THE DRAWINGS

Aforementioned objects and other objects and characteristics of the present invention will be made more apparent from description of the following embodiment in view of the accompanying drawings. Of these drawings:

FIG. 1 is a schematic hardware configuration diagram of a part supply amount estimating device according to one embodiment;

FIG. 2 is a schematic functional block diagram of the part supply amount estimating device according to one embodiment;

FIG. 3 is a schematic functional block diagram illustrating one form of the part supply amount estimating device;

FIG. 4A is a view for explaining a neuron;

FIG. 4B is a view for explaining a neural network;

FIG. 5 is a schematic functional block diagram of the part supply amount estimating device according to another embodiment;

FIG. 6 is a view illustrating an example of an ideal manufacturing process of a manufacturing product; and

FIG. 7 is a view illustrating an example of an actual manufacturing process of the manufacturing product.

### DETAILED DESCRIPTION OF THE PREFERRED EMBODIMENTS

An embodiment of the present invention will be described below with reference to the drawings.

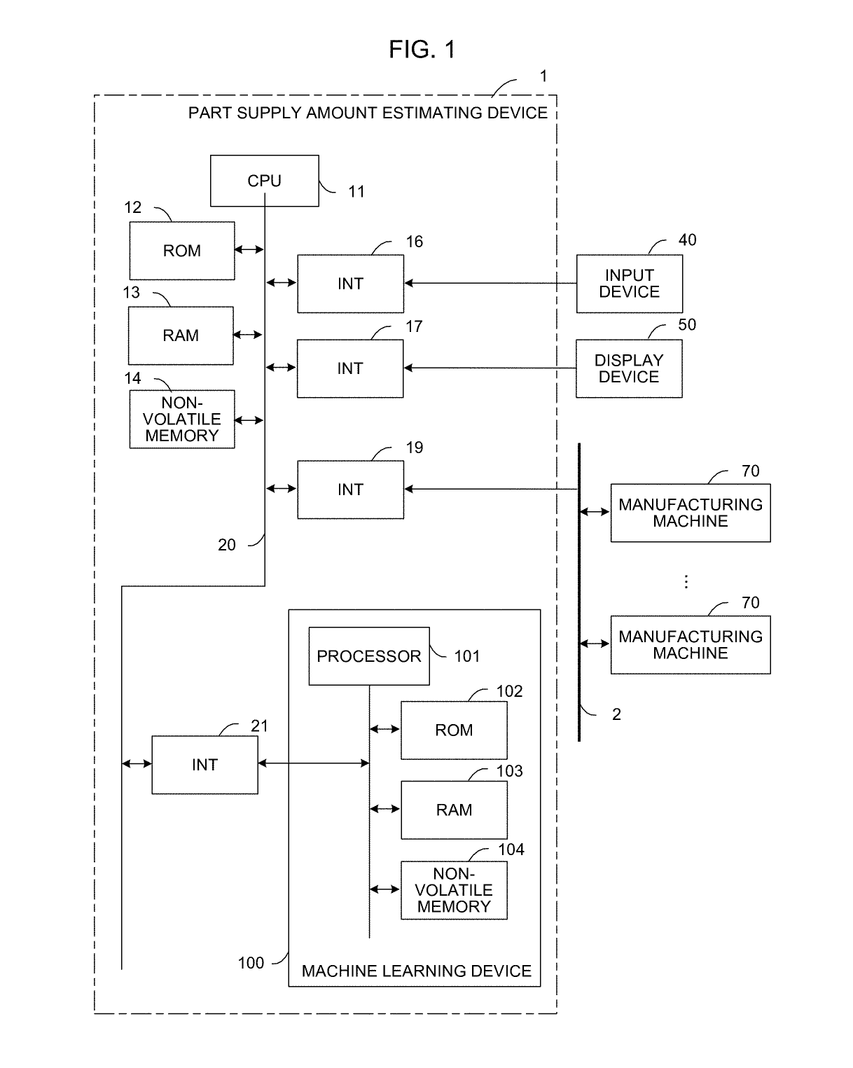

FIG. 1 is a schematic hardware configuration diagram illustrating main units of a part supply amount estimating device according to a first embodiment. A part supply amount estimating device 1 can be mounted as a personal computer installed together with a control device which controls manufacturing machines 70 such as machine tools. Furthermore, the part supply amount estimating device 1 can be mounted as a computer such as a cell computer, a host computer, an edge server or a cloud server. The present embodiment will describe an example of a case where the part supply amount estimating device 1 is mounted as a computer connected with the control device which controls the manufacturing machines 70 installed in a factory via a wired/wireless network.

A CPU 11 included in the part supply amount estimating device 1 according to the present embodiment is a processor which entirely controls the part supply amount estimating device 1. The CPU 11 reads a system program stored in a ROM 12 via a bus 20, and controls the entire part supply amount estimating device 1 according to the system program. Temporary calculation data and various items of data inputted by an operator via an unillustrated input unit are temporarily stored in a RAM 13.

A non-volatile memory 14 is configured as a memory which is backed up by, for example, an unillustrated battery, and maintains a storage state even when the part supply amount estimating device 1 is powered off. Various items of data inputted by the operator by operating an input device 40, data obtained from the manufacturing machines 70 via an interface 19, and programs inputted via an unillustrated interface are stored in the non-volatile memory 14. The programs and the various items of data stored in the non-volatile memory 14 may be expanded to the RAM 13 during execution/use. Furthermore, a system program including a known analysis program which analyzes information obtained from the manufacturing machine 70, and a system program which controls exchanges with a machine learning device 100 described below are written in advance in the ROM 12.

An interface 21 is an interface which connects the part supply amount estimating device 1 and the machine learning device 100. The machine learning device 100 includes a processor 101 which controls the entire machine learning device 100, a ROM 102 which stores system programs, a RAM 103 which performs temporary storage during each processing according to machine learning, and a non-volatile memory 104 which is used to store a learning model. The machine learning device 100 can observe each information which can be obtained by the part supply amount estimating device 1 via the interface 21. Furthermore, the part supply amount estimating device 1 displays information outputted from the machine learning device 100 on a display device 50 via an interface 17.

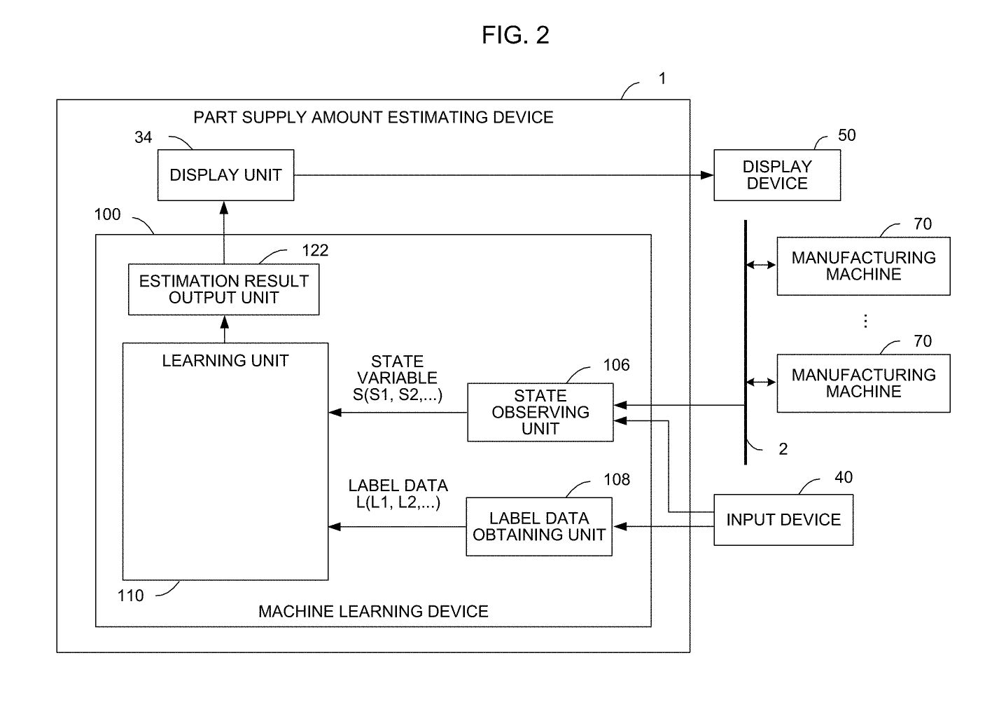

FIG. 2 is a schematic functional block diagram of the part supply amount estimating device 1 and the machine learning device 100 according to the first embodiment. Each functional block illustrated in FIG. 2 is realized when the CPU 11 included in the part supply amount estimating device 1 illustrated in FIG. 1 and the processor 101 of the machine learning device 100 execute the respective system programs, and control an operation of each unit of the part supply amount estimating device 1 and the machine learning device 100.

The part supply amount estimating device 1 according to the present embodiment includes a display unit 34 which displays on the display device 50 an instruction for the operator outputted from the machine learning device 100.

The display unit 34 is function means which displays on the display device 50 an estimation result of a part margin which has been outputted from the machine learning device 100 and is necessary to manufacture a manufacturing product. The display unit 34 may display as is on the display device 50 the part margin which has been outputted from the machine learning device 100 and is necessary to manufacture the manufacturing product. Alternatively, when a manufacturing number of manufacturing products or the number of parts necessary for the manufacturing products is inputted in advance, the number of parts which need to be supplied may be calculated based on these numerical values and the part margin to display on the display device 50.

On the other hand, the machine learning device 100 included in the part supply amount estimating device 1 includes software (learning algorithm) and hardware (processor 101) which learn estimation of the part margin necessary to manufacture the manufacturing product by way of so-called machine learning based on information related to the manufacturing product and information related to manufacturing environment for manufacturing the manufacturing product. What the machine learning device 100 included in the part supply amount estimating device 1 corresponds to a model structure indicating a correlation between the information related to the manufacturing product and information related to the manufacturing environment for manufacturing the machined product, and the part margin necessary to manufacture the manufacturing product.

As illustrated in the functional block in FIG. 2, the machine learning device 100 included in the part supply amount estimating device 1 includes a state observing unit 106 which observes manufacturing product data S1 indicating the information of the manufacturing products and manufacturing environment data S2 indicating the information related to the manufacturing environment for manufacturing the manufacturing product as a state variable S indicating a current state of environment, a label data obtaining unit 108 which obtains label data L including part margin data L1 indicating the part margin necessary to manufacture the manufacturing product, a learning unit 110 that associates and learns the information related to the manufacturing product and the information related to the manufacturing environment for manufacturing the manufacturing product, and the part margin necessary to manufacture the manufacturing product by using the state variable S and the label data L, and an estimation result output unit 122 which outputs the part margin which has been estimated from the information related to the manufacturing product and the information related to the manufacturing environment for manufacturing the manufacturing product by using a pre-trained model of the learning unit 110, and is necessary to manufacture the manufacturing product.

The state observing unit 106 obtains the manufacturing product data S1 and the manufacturing environment data S2 as the state variable S from the input device 40 and the manufacturing machines 70 during learning of the learning unit 110. Furthermore, the state observing unit 106 obtains the manufacturing product data S1 and the manufacturing environment data S2 as the state variable S from the input device 40 and the manufacturing machine 70 while the part margin necessary to manufacture the manufacturing product is estimated by using a learning result of the learning unit 110. In addition, in each case, instead of directly obtaining the data from the input device 40 and the manufacturing machines 70, data may be obtained via the non-volatile memory 14 included in the part supply amount estimating device 1.

When the manufacturing product data S1 among the state variable S observed by the state observing unit 106 is simply configured, part types used to manufacture manufacturing products, the numbers of respective parts and required precision (or a tolerance) can be used. The part types used to manufacture the manufacturing products, the numbers of respective parts and the required precision (or a tolerance) may be inputted by the operator via the input device 40, or may be extracted from data obtained from the manufacturing machines 70 and related to manufacturing based on an instruction of the operator.

On the other hand, when the manufacturing environment data S2 among the state variable S observed by the state observing unit 106 is simply configured, machining conditions (a machine in use, a feed rate, a spindle rotational speed, a torque, a stroke and a temperature) of the manufacturing machines 70 for manufacturing the manufacturing products, and tool information (a tool type, a tool material and a tool abrasion loss) can be used. Furthermore, a location condition, a manufacturing period (summer and winter) and a manufacturing time zone (noon or midnight) may be employed as the manufacturing environment data S2. The information related to the manufacturing environment for manufacturing the manufacturing product of the manufacturing machines 70 may be inputted by the operator via the input device 40 or may be obtained from the manufacturing machine 70 according to the instruction of the operator.

The label data obtaining unit 108 obtains the label data L including the part margin data L1 indicating the part margin necessary to manufacture the manufacturing product as the label data L during learning of the learning unit 110. The part margin data L1 can be defined as, for example, the margin of the parts (a rate to supply as a surplus) supplied to manufacture the manufacturing product. The part margin necessary to manufacture the manufacturing product may be inputted by the operator via the input device 40 or may be obtained from an unillustrated production management device via a network 2 based on an instruction of the operator.

In addition, the label data obtaining unit 108 is an indispensable component at a stage of learning of the learning unit 110, yet is not necessarily the indispensable component after the learning unit 110 finishes associating and learning the information related to the manufacturing product and the information related to the manufacturing environment for manufacturing the manufacturing product, and the part margin necessary to manufacture the manufacturing product. When, for example, the machine learning device 100 which has finished learning is shipped to a client, the label data obtaining unit 108 may be detached, and the machine learning device 100 may be shipped.

The learning unit 110 learns the label data L (the part margin data L1 indicating the part margin necessary to manufacture the manufacturing product) of the state variable S (the manufacturing product data S1 indicating the information related to the manufacturing product and the manufacturing environment data S2 indicating the information related to the manufacturing environment for manufacturing the manufacturing product) according to an optional learning algorithm which is collectively referred to as machine learning. The learning unit 110 can learn the correlation between, for example, the manufacturing product data S1 and the manufacturing environment data S2 included in the state variable S, and the part margin data L1 included in the label data L. The learning unit 110 can repeatedly execute learning based on a data set including the state variable S and the label data L.

When the learning unit 110 performs learning, a plurality of learning cycles is desirably executed based on data obtained during manufacturing of multiple manufacturing products. By repeating these learning cycles, the learning unit 110 automatically interprets the correlation between the information (manufacturing product data S1) related to the manufacturing product and the information (manufacturing environment data S2) related to the manufacturing environment for manufacturing the manufacturing product, and the part margin (part margin data L1) necessary to manufacture the manufacturing product. The correlation of the part margin data L1 with respect to the manufacturing product data S1 and the manufacturing environment data S2 is substantially unknown at a start of the learning algorithm. However, as the learning unit 110 advances learning, it is possible to gradually interpret a relationship of the part margin data L1 with respect to the manufacturing product data S1 and the manufacturing environment data S2, and interpret the correlation to the part margin data L1 with respect to the manufacturing product data S1 and the manufacturing environment data S2 by using the pre-trained model obtained as a result.

The estimation result output unit 122 estimates the part margin necessary to manufacture the manufacturing product based on the information related to the manufacturing product and the information related to the manufacturing environment for manufacturing the manufacturing product, based on the result (pre-trained model) learned by the learning unit 110, and outputs the estimated part margin necessary to manufacture the manufacturing product. The part margin data L1 which is learned by the learning unit 110 in association with the manufacturing product data S1 indicating the information related to the manufacturing product and the manufacturing environment data S2 indicating the information related to the manufacturing environment for manufacturing the manufacturing product, and is necessary to manufacture the manufacturing product is used to estimate the part margin necessary to manufacture the manufacturing product when a new manufacturing product is manufactured.

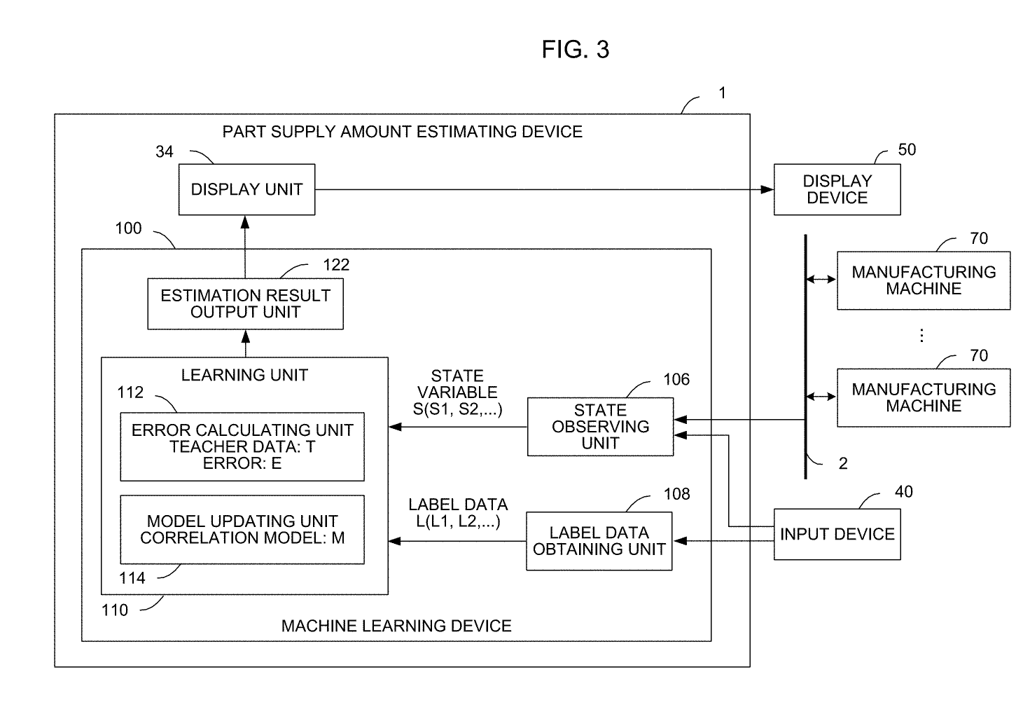

In the machine learning device 100 employing the above configuration, the learning algorithm executed by the learning unit 110 is not limited in particular, and a known learning algorithm can be employed as machine learning. FIG. 3 illustrates another form of the part supply amount estimating device 1 illustrated in FIG. 2, and illustrates a configuration including the learning unit 110 which executes supervised learning as another example of the learning algorithm. The supervised learning is a method for learning a correlation model for estimating a required output with respect to a new input by identifying a feature implicitly indicating the correlation between an input and an output based on items of teacher data when a known data set (referred to as the teacher data) of the input and the output for the input is obtained.

In the machine learning device 100 included in the part supply amount estimating device 1 illustrated in FIG. 3, the learning unit 110 includes an error calculating unit 112 which calculates an error E between a correlation model M for estimating the part margin necessary for manufacturing the manufacturing products from the information related to the manufacturing product, and the correlation feature identified from teacher data T obtained from the result of the part margin which is based on previously obtained information related to the manufacturing product, previously obtained information related to the manufacturing environment for manufacturing the manufacturing product, and the information related to the manufacturing product detected by a sensor, and which is necessary to manufacture the manufacturing product and a model updating unit 114 which updates the correlation model M to reduce the error E. When the model updating unit 114 repeats updating the correlation model M, the learning unit 110 learns estimation of the part margin necessary for manufacturing the manufacturing products from the information related to the manufacturing product and the information related to the manufacturing environment for manufacturing the manufacturing product.

An initial value of the correlation model M is expressed by simplifying the correlation between the state variable S and the label data L (e.g., N-order function), and is given to the learning unit 110 before supervised learning starts. As described above, according to the present invention, the teacher data T can use the previously obtained information related to the manufacture products, the previously obtained information related to the manufacturing environment for manufacturing the manufacturing product, and the information of the part margin necessary to manufacture the manufacturing product, and is occasionally given to the learning unit 110 during the operation of the part supply amount estimating device 1. The error calculating unit 112 identifies the correlation feature implicitly indicating the correlation between the information related to the manufacturing product and the information related to the manufacturing environment for manufacturing the manufacturing product, and the part margin necessary to manufacture the manufacturing product, based on teacher data T occasionally given to the learning unit 110, and calculates the error E between this correlation feature, and the correlation model M matching the state variable S and the label data L in the current state. The model updating unit 114 updates the correlation model M in a direction in which the error E is reduced according to, for example, a predetermined update rule.

In a next learning cycle, the error calculating unit 112 estimates the part margin necessary to manufacture the manufacturing product by using the state variable S according to the updated correlation model M, and calculates the error E between a result of the estimation and the actually obtained label data L, and the model updating unit 114 updates the correlation model M again. In this way, a correlation between an unknown current state of environment and estimation of the environment gradually becomes clear.

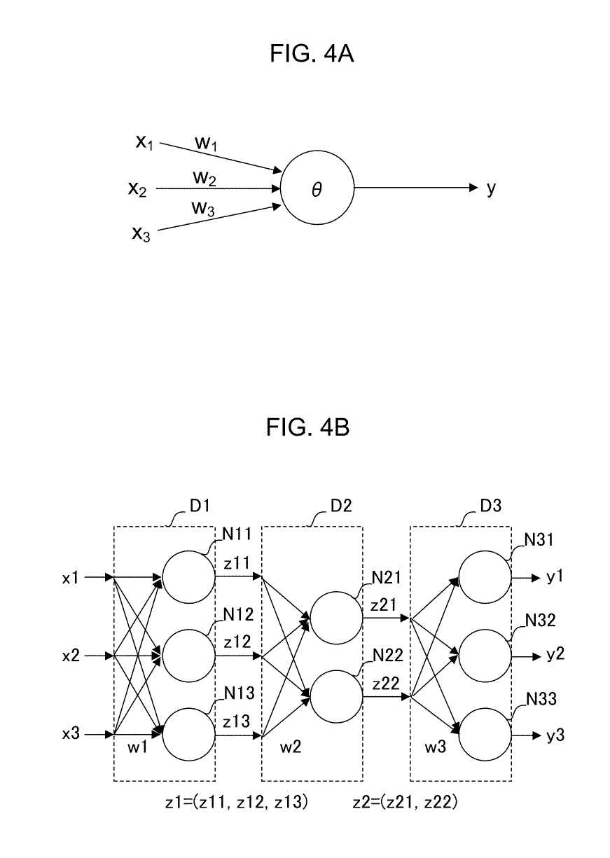

When the above-described supervised learning is advanced, the neural network can be used. FIG. 4A schematically illustrates a neuron model. FIG. 4B schematically illustrates a model of a three-layer neural network configured by combining neurons illustrated in FIG. 4A. The neural network can be configured by an arithmetic device and a storage device which imitate, for example, a neuron model.

The neuron illustrated in FIG. 4A outputs a result y of a plurality of inputs x (an input x₁ to an input x₃ in one example). Each of the inputs x₁ to x₃ is multiplied with a weight w (w₁ to w₃) matching this input x. Thus, the neuron outputs the output y expressed according to following equation 1. In addition, the input x, the output y and the weight w are all vectors in equation 1. Furthermore, θ is a bias, and fₖ is an activation function.

y=fₖ(Σᵢ₌₁ⁿxᵢwᵢ−θ) [Mathematical 1]

The three-layer neural network illustrated in FIG. 4B receives an input of a plurality of inputs x (the input x1 to the input x3 in one example) from the left side, and outputs the result y (a result y1 to a result y3 in one example) from the right side. In the example illustrated in FIG. 4B, each of the inputs x1, x2 and x3 is multiplied with a corresponding weight (collectively represented as w1), and the individual inputs x1, x2 and x3 are inputted to three neurons N11, N12 and N13, respectively.

In FIG. 4B, each output of the neurons N11 to N13 is collectively represented by z1. z1 can be regarded as a feature vector obtained by extracting a feature amount of an input vector. In the example illustrated in FIG. 4B, each of the feature vector z1 is multiplied with a corresponding weight (collectively represented as w2), and the individual feature vectors z1 are inputted to two neurons N21 and N22, respectively. The feature vector z1 represents a feature between a weight W1 and a weight W2.

In FIG. 4B, the output of each of the neurons N21 and N22 will be collectively represented as z2. z2 can be regarded as a feature vector obtained by extracting a feature amount of the feature vector z1. In the example illustrated in FIG. 4B, each of the feature vector z2 is multiplied with a corresponding weight (collectively represented as w3), and the individual feature vectors z2 are inputted to three neurons N31, N32 and N33, respectively. The feature vector z2 indicates a feature between the weight W2 and a weight W3. The neurons N31 to N33 lastly output results y1 to y3, respectively.

In addition, it is also possible to use a so-called deep learning method which uses a neural network which forms three or more layers.

In the machine learning device 100 included in the part supply amount estimating device 1, the learning unit 110 can estimate the part margin (output y) necessary to manufacture the manufacture product from the information related to the manufacturing product and the information (input x) related to manufacturing environment for manufacturing the manufacturing product by using the state variable S as the input x and performing an arithmetic operation on the multilayer structure according to the above neural network. In addition, operation modes of the neural network include a learning mode and a value prediction mode. For example, a learning data set is used to learn the weight w in the learning mode, and a value of a behavior can be decided in the value prediction mode by using the learned weight w. In addition, according to a value prediction mode, it is also possible to perform detection, classification and reasoning.

The above configuration of the machine learning device 100 can be described as a machine learning method (or software) executed by the processor 101. This machine learning method is a machine learning method for learning (estimation of) the part margin necessary to manufacture the manufacturing product from the information related to the manufacturing product and the information related to the manufacturing environment for manufacturing the manufacturing product, and the processor 101 includes: a step of observing information (manufacturing product data S1) related to the manufacturing product and information (manufacturing environment data S2) related to the manufacturing environment for manufacturing the manufacturing product as a state variable S indicating a current state; a step of obtaining the part margin (part margin data L1) necessary to manufacture the manufacturing product as the label data L; and a step of associating and learning the manufacturing product data S1 and the manufacturing environment data S2, and the part margin necessary to manufacture the manufacture product by using the state variable S and the label data L.

The pre-trained model learned and obtained by the learning unit 110 of the machine learning device 100 can be used as a program module which is part of software according to machine learning. The pre-trained model according to the present invention can be used by the computer including the processor such as a CPU or a GPU, and a memory. More specifically, the processor of the computer operates to perform an arithmetic operation by using the information related to the manufacturing product and the information related to the manufacturing environment for manufacturing the manufacturing product as inputs according to an instruction from the pre-trained model stored in the memory, and output an estimation result of the part margin necessary to manufacture the manufacturing product based on an arithmetic operation result. The pre-trained model according to the present invention can be copied to another computer via an external storage medium and a network, and used.

Furthermore, when the pre-trained model according to the present invention is copied to another computer and used in new environment, it is possible to cause the pre-trained model to perform further learning based on a new state variable and label data obtained in the environment. In this case, a pre-trained model (referred to as a derived model below) deriving from the pre-trained model in the environment can be obtained. The derived model according to the present invention is the same as the original pre-trained model in that the derived model outputs the estimation result of the part margin necessary to manufacture the manufacturing product from the information related to the manufacturing product and the information related to the manufacturing environment for manufacturing product, yet differs in outputting a result which is more adapted to new environment than the original pre-trained model. This derived model can be also copied to another computer via an external storage medium and a network, and used.

Furthermore, by using an output obtained from an input to the machine learning device in which the pre-trained model according to the present invention is implemented, it is possible to create the pre-trained model (referred to as a distillation model below) obtained by performing learning from the beginning in another machine learning device, and use this pre-trained model (such a learning process will be referred to as distillation). According to distillation, the original pre-trained model will be referred to as a teacher model, and a distillation model to be newly created will be referred to as a student model. Generally, the distillation model has a smaller size than the original pre-trained model yet provides equivalent accuracy to that of the original pre-trained model, and consequently is suitable for distribution to another computer via an external storage medium or a network.

A purpose to use the part supply amount estimating device 1 according to the present embodiment is to the most typically estimate the part margin necessary to manufacture the manufacturing product based on the information related to the manufacturing product to be manufactured and the information related to the manufacturing environment before the manufacturing product is manufactured, and can be also used for other purposes.

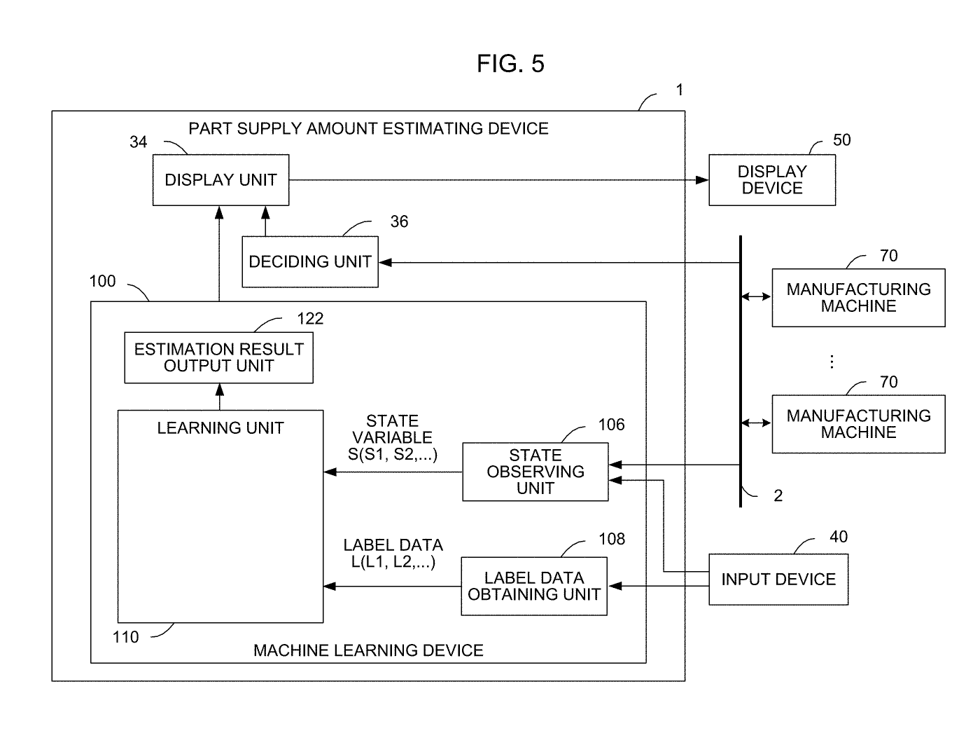

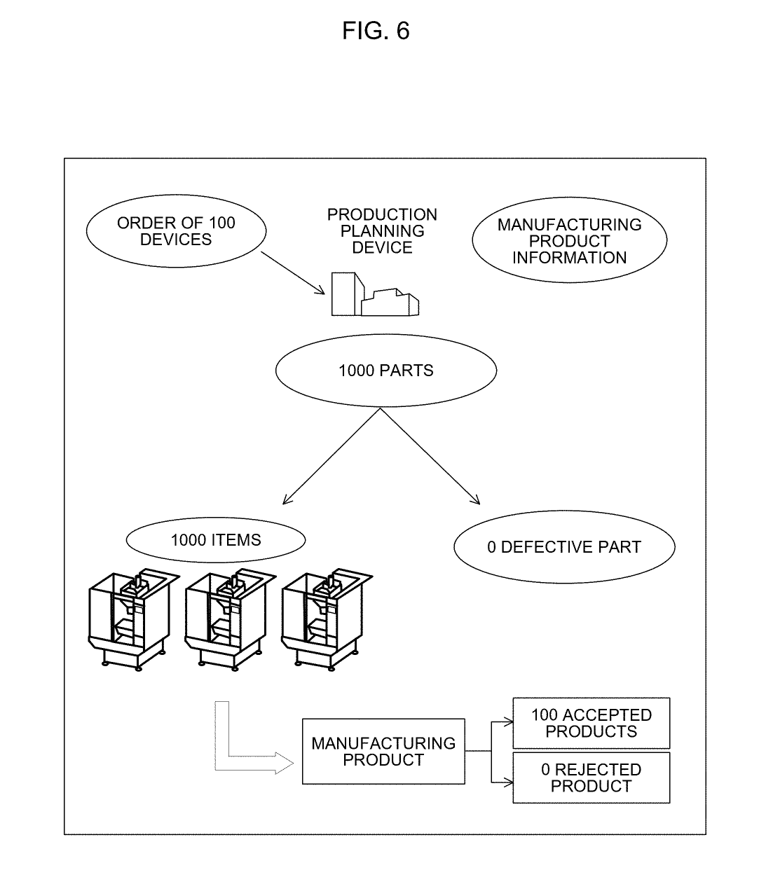

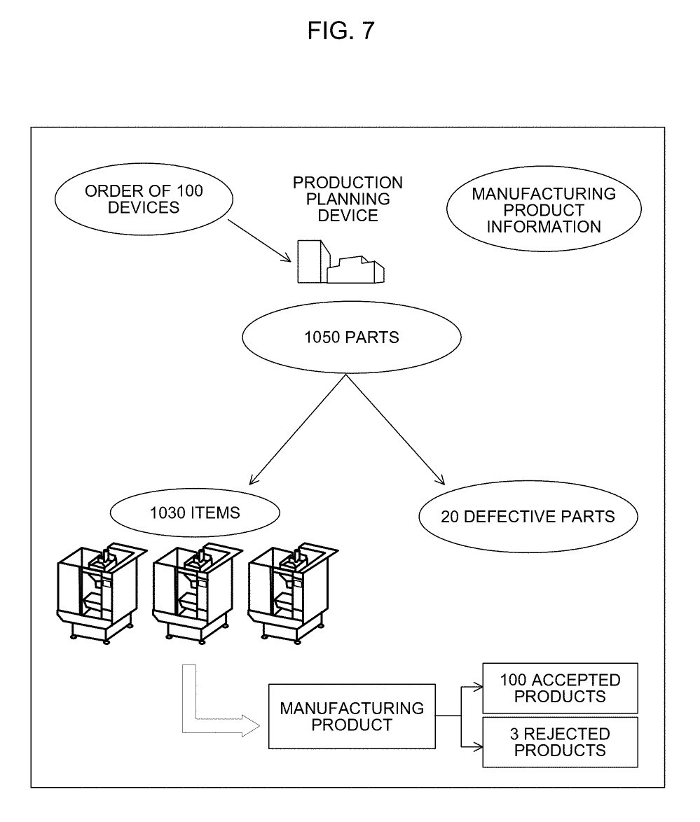

When, for example, parts are supplied by taking into account the part margin which has been estimated by the part supply amount estimating device 1 and is necessary to manufacture the manufacturing product, a manufacturing product is manufactured and parts become substantially insufficient as a result, it is possible to decide that a supplier of parts or the manufacturing machine used for manufacturing has a problem, and make a future countermeasure (change a part supplier or change the manufacturing machine used for manufacturing) by checking the amount of defective parts and the amount of rejected parts. It is also possible to cause a deciding unit 36 in the block diagram illustrated in FIG. 5 to make the above decision based on data obtained via the network 2 and related to manufacturing, and cause the display device 50 to display the decision.

Furthermore, it may be possible to cause the deciding unit 36 in the block diagram illustrated in FIG. 5 to obtain the number of parts supplied via the network 2, and, when the number of parts is far from the number of parts calculated from the part margin which has been outputted from an estimation result output unit 122 and is necessary to manufacture the manufacturing product, instruct the display unit 34 to display that there is likely to be a supply mistake on the display device 50.

When manufacturing a certain manufacturing product, the part supply amount estimating device 1 can estimate the part margin necessary to manufacture the manufacturing product in a case where each of a plurality of manufacturing machines 70 manufactures the manufacturing product, and decide to manufacture the manufacturing product by using the manufacturing machine 70 for which the least part margin is predicted.

For a manufacturing product manufactured via a plurality of processes, it is also possible to make an application of estimating the part margin in each manufacturing process for each manufacturing machine, and selecting the manufacturing machine to use for each process based on an estimation result. When, for example, it is estimated for the first process that the part margin is small in a case of manufacturing using a manufacturing machine a and the part margin is large in a case of manufacturing using a manufacturing machine β, and it is estimated for the second process that the part margin is large in a case of manufacturing using the manufacturing machine a and the part margin is small in a case of manufacturing using the manufacturing machine β, and it is possible to make decision to use the manufacturing machine α in the first process and use the manufacturing machine β in the second process.

The embodiment according to the present invention has been described above. However, the present invention is not limited only to the example of the above embodiment and can be carried out in various modes by adding optional changes.

For example, the learning algorithm and the arithmetic algorithm executed by the machine learning device 100, and the control algorithm executed by the part supply amount estimating device 1 are not limited to the above, and various algorithms can be adopted.

Furthermore, the above embodiment has described the part supply amount estimating device 1 and the machine learning device 100 as devices including different CPUs. However, the machine learning device 100 may be realized by the CPU 11 included in the part supply amount estimating device 1, and the system program stored in the ROM 12.

The embodiment of the present invention has been described above. However, the present invention is not limited to the example of the above embodiment and can be carried out in other modes by adding optional changes.

1. A part supply amount estimating device that estimates a part margin used to manufacture a manufacturing product, the part supply amount estimating device comprising a machine learning device that learns the part margin used to manufacture the manufacturing product,
wherein the machine learning device includes:
a state observing unit that observes manufacturing product data and manufacturing environment data as a state variable, the manufacturing product data indicating information related to the manufacturing product, the manufacturing environment data indicating information related to machining environment for manufacturing the manufacturing product, and the state variable indicating a current state of environment;
a label data obtaining unit that obtains the part margin necessary to manufacture the manufacturing product as label data; and
a learning unit that associates and learns the information related to the manufacturing product and the information related to the machining environment for manufacturing the manufacturing product, and the part margin necessary to manufacture the manufacturing product by using the state variable and the label data.

2. The part supply amount estimating device according to claim 1,
wherein the learning unit includes: an error calculating unit that calculates an error between a correlation model and a correlation feature, the correlation model estimating from the state variable the part margin necessary to manufacture the manufacturing product, and the correlation feature being identified from teacher data prepared in advance; and a model updating unit that updates the correlation model to reduce the error.

3. The part supply amount estimating device according to claim 1,
wherein the learning unit performs an arithmetic operation on the state variable and the label data by a multilayer structure.

4. A part supply amount estimating device that estimates a part margin used to manufacture a manufacturing product, the part supply amount estimating device comprising a machine learning device that learns the part margin used to manufacture the manufacturing product,
wherein the machine learning device includes:
a state observing unit that observes manufacturing product data and manufacturing environment data as a state variable, the manufacturing product data indicating information related to the manufacturing product, the manufacturing environment data indicating information related to machining environment for manufacturing the manufacturing product, and the state variable indicating a current state of environment;
a learning unit that associates and learns the information related to the manufacturing product and the information related to the machining environment for manufacturing the manufacturing product, and the part margin necessary to manufacture the manufacturing product; and
an estimation result output unit that outputs a result obtained by estimating the part margin necessary to manufacture the manufacturing product, based on the state variable observed by the state observing unit and a learning result of the learning unit.

5. The part supply amount estimating device according to claim 1,
wherein the machine learning device is in a cloud server.

6. A machine learning device that learns a part margin used to manufacture a manufacturing product, the machine learning device comprising:
a state observing unit that observes manufacturing product data and manufacturing environment data as a state variable, the manufacturing product data indicating information related to the manufacturing product, the manufacturing environment data indicating information related to machining environment for manufacturing the manufacturing product, and the state variable indicating a current state of environment;
a label data obtaining unit that obtains the part margin necessary to manufacture the manufacturing product as label data; and
a learning unit that associates and learns the information related to the manufacturing product and the information related to the machining environment for manufacturing the manufacturing product, and the part margin necessary to manufacture the manufacturing product by using the state variable and the label data.

7. A machine learning device that learns a part margin used to manufacture a manufacturing product, the machine learning device comprising:
a state observing unit that observes manufacturing product data and manufacturing environment data as a state variable, the manufacturing product data indicating information related to the manufacturing product, the manufacturing environment data indicating information related to machining environment for manufacturing the manufacturing product, and the state variable indicating a current state of environment;
a learning unit that associates and learns the information related to the manufacturing product and the information related to the machining environment for manufacturing the manufacturing product, and the part margin necessary to manufacture the manufacturing product; and
an estimation result output unit that outputs a result obtained by estimating the part margin necessary to manufacture the manufacturing product, based on the state variable observed by the state observing unit and a learning result of the learning unit.
